(19) United States
(12) Patent Application Publication
(10) Pub. No.: US 2019/0356891 A1
(43) Pub. Date: Nov. 21, 2019

(54) HIGH DYNAMIC RANGE (HDR) DATA CONVERSION AND COLOR SPACE MAPPING

(71) Applicant: Synaptics Incorporated, San Jose, CA (US)

(72) Inventors: Chang Q. ZHANG, San Jose, CA (US); Jun ZHANG, San Jose, CA (US); Chandranath MANCHI, Bangalore (IN); Yicai YING, Santa Clara, CA (US)

(21) Appl. No.: 16/370,608

(22) Filed: Mar. 29, 2019

(30) Foreign Application Priority Data
May 16, 2018 (IN) 201821018272

(51) Int. Cl. H04N 9/73; H04N 7/01; H04N 11/20

(52) U.S. Cl. CPC H04N 9/73; H04N 11/20; H04N 7/01

(57) ABSTRACT

A method and apparatus for image processing. A data conversion and color-space mapping (DCM) circuit includes an inverse opto-electrical transfer function (IOETF), a color-space converter, and a color-space re-mapper. The IOETF receives image data for one or more frames acquired by an image capture device and transfers the image data from a non-linear domain to a linear domain. The color-space converter converts the linear image data from a first color space to a second color space, where each of the first and second color spaces is based on a gamut of the image capture device. The color-space re-mapper processes the image data to be rendered on a display device by remapping the converted image data from the second color space to a third color space, where the third color space is based on a gamut of the display device.

### CROSS-REFERENCE TO RELATED APPLICATION

This application claims priority under 35 U.S.C. 119(b) to co-pending and commonly-owned Indian Provisional Patent Application No. 201821018272, entitled “HIGH DYNAMIC RANGE (HDR) DATA CONVERSION AND COLOR SPACE MAPPING,” filed on May 16, 2018, the entirety of which is incorporated by reference herein.

### TECHNICAL FIELD

The present embodiments relate generally to digital imaging, and specifically to data conversion and color space mapping between various imaging standards.

### BACKGROUND OF RELATED ART

Display devices (e.g., televisions, set-top boxes, computers, mobile phones, etc.) may use different imaging technologies than those used by image capture devices (e.g., cameras, video recorders, etc.). Advancements in display technologies have resulted in improved capabilities such as wider Color Gamut and migration from High definition display to Ultra High definition display technologies. As a result, image processing may be required to properly render, on a given display, images captured by devices with different system capabilities and standards. Specifically, it may be desirable to pre-process the source image to produce more realistic images at the display (e.g., making use of the full dynamic range of the display).

Image processing enables a captured image to be rendered on a display such that the original image capture environment can be reproduced as accurately as possible given the capabilities (or limitations) of the display technology. For example, a display device that is capable of displaying only standard dynamic range (SDR) content may be unable to reproduce the full range of color, brightness, and/or contrast of an image captured in a high dynamic range (HDR) format. Thus, image processing may reduce some of the color, brightness, and/or contrast of the HDR image in order to be rendered on an SDR display. Even an HDR display may require some amount of image processing to be performed on the HDR image due to differences between the display environment (e.g., a television with electronically-limited brightness, color, contrast, and resolution) and the image capture environment (e.g., a natural environment with unlimited brightness, color, contrast, and resolution). Thus, the image display is not merely the inverse of the image capture.

### SUMMARY

This Summary is provided to introduce in a simplified form a selection of concepts that are further described below in the Detailed Description. This Summary is not intended to identify key features or essential features of the claims subject matter, nor is it intended to limit the scope of the claimed subject matter.

A method and apparatus for image processing is disclosed. One innovative aspect of the subject matter of this disclosure can be implemented in method of image processing. In some embodiments, the method may include steps of receiving image data for one or more frames acquired by an image capture device; transferring the received image data from a non-linear domain to a linear domain using an inverse opto-electrical transfer function (IOETF); converting the linear image data from a first color space to a second color space, where the first and second color spaces are based on a gamut of the image capture device; and processing the image data to be rendered on a display device by remapping the converted image data from the second color space to a third color space, where the third color space is based on a gamut of the display device.

Another innovative aspect of the subject matter of this disclosure can be implemented in a data conversion and color-space mapping (DCM) circuit. In some embodiments, the DCM circuit may include an IOETF, a first color-space converter, and a color-space re-mapper. The IOETF is configured to receive image data for one or more frames acquired by an image capture device and transfer the image data from a non-linear domain to a linear domain. The first color-space converter is configured to convert the linear image data from a first color space to a second color space, where each of the first and second color spaces is based on a gamut of the image capture device. The color-space re-mapper is configured to process the image data to be rendered on a display device by remapping the converted image data from the second color space to a third color space, where the third color space is based on a gamut of the display device.

Another innovative aspect of the subject matter of this disclosure can be implemented in a system comprising a display device, configured to display one or more frames acquired by an image capture device, and a DCM circuit. In some embodiments, the DCM circuit may be configured to receive image data for the one or more frames; transfer the received image data from a non-linear domain to a linear domain using an IOETF; convert the linear image data from a first color space to a second color space, where each of the first and second color spaces is based on a gamut of the image capture device; and remap the converted image data from the second color space to a third color space, where the third color space is based on a gamut of the display device.

### BRIEF DESCRIPTION OF THE DRAWINGS

The present embodiments are illustrated by way of example and are not intended to be limited by the figures of the accompanying drawings.

FIG. 1 shows a block diagram of an image capture and display system, in accordance with some embodiments.

FIG. 2 shows a block diagram of a video post-processing (VPP) pipeline that may be used to transfer images from different image capture devices with different system capabilities and standards to an image display device, in accordance with some embodiments.

FIG. 3 shows a block diagram of a data conversion and color-space mapping (DCM) circuit, in accordance with some embodiments.

FIG. 4 shows a block diagram of an electrical-to-electrical transfer function (EETF) 400, in accordance with some embodiments.

FIG. 5 shows another block diagram of a DCM circuit, in accordance with some embodiments.

FIG. 6 shows another block diagram of a DCM circuit, in accordance with some embodiments.

FIG. 7 shows a block diagram of a DCM circuit with dynamic range detection, in accordance with some embodiments.

FIG. 8 shows another block diagram of a DCM circuit with dynamic range detection, in accordance with some embodiments.

FIG. 9 shows a block diagram of a dynamic range detector, in accordance with some embodiments.

FIG. 10 shows a block diagram of a luminance detector, in accordance with some embodiments.

FIG. 11 is an illustrative flowchart depicting an example image processing operation, in accordance with some embodiments.

FIG. 12 is an illustrative flowchart depicting an example operation for dynamic range detection, in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein may refer to any general purpose processor, conventional processor, controller, microcontroller, and/or state machine capable of executing scripts or instructions of one or more software programs stored in memory.

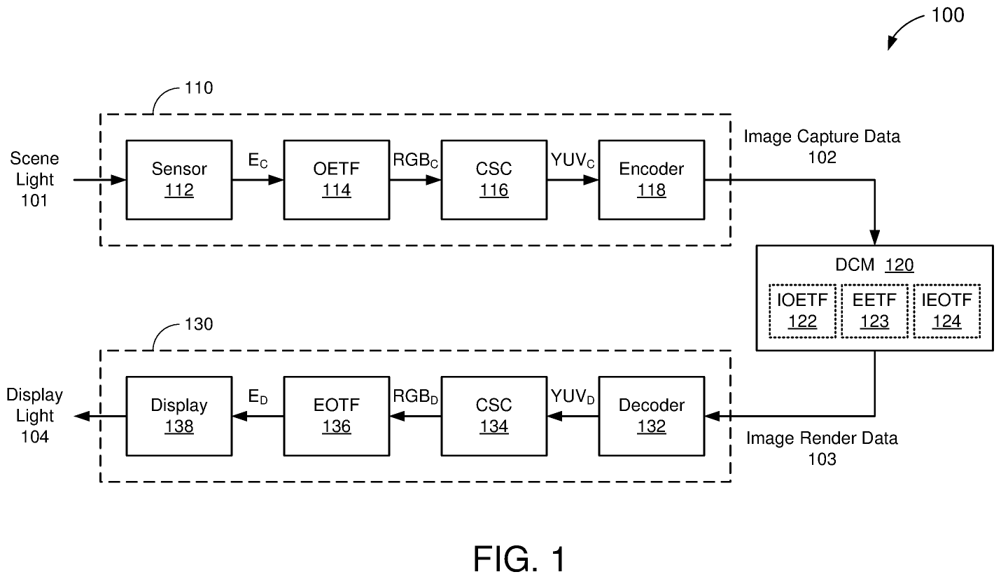

FIG. 1 shows a block diagram of an image capture and display system 100, in accordance with some embodiments. The system includes an image capture device 110, a data conversion and color space mapping (DCM) circuit 120, and an image display device 130. The image capture device 110 captures a pattern of light (e.g., as scene light 101) and converts the captured light to a digital image. The image display device 130 displays the digital image by reproducing the light pattern (e.g., as display light 104) on a corresponding display surface. In some aspects, the image capture device 110 may be a camera and the image display device 130 may be a television or computer monitor.

The image capture device 110 includes a sensor 112, an opto-electrical transfer function (OETF) 114, a color-space converter (CSC) 116, and an encoder 118. The sensor 112 converts the scene light 101 to an electrical signal (E_{C}) representing raw RGB values. In some embodiments, the sensor 112 may include an array of optical sensing elements (e.g., charge-coupled device (CCD) or complementary metal-oxide-semiconductor (CMOS) cells), each configured to sample a respective pixel of the scene light 101.

The OETF 114 converts the electrical signal Ec to coded RGB image data (RGB_{C}) that can be used to reproduce the captured image on the image display device 130. In some aspects, the OETF 114 may transfer RGB information from the analog to digital domain. For example, the OETF 114 may convert the analog electrical signals Ec to digital Red, Green, and Blue (RGB) values representing the primary color components associated with the sensor 112.

The CSC 116 changes the color space of the coded RGB image data RGB_{C}. In some embodiments, the CSC 116 may convert the coded RGB image data RGB_{C} from the RGB color space to a different color space, which may be easier to compress and transmit over a channel, for example, between the image capture device 110 and the image display device 130. An example of such color space is a YUV color space. The YUV color space may be more conducive to image processing than the RGB color space. In some implementations, the CSC 116 may convert the coded RGB image data RGB_{C} to YUV image data YUV_{C}. The converted YUV image data YUV_{C} may describe the luminance (Y) and chrominance (UV) components of each pixel.

The encoder 118 encodes the converted YUV image data YUV_{C} (e.g., as image capture data 102) for transmission to the DCM 120 and/or image display device 130. For example, the encoder 118 may apply data compression and/or signal modulation to the converted YUV image data YUV_{C} based, at least in part, on the standards and protocols implemented by the transmission medium and/or the image display device 130.

The DCM circuit 120 performs image processing on the image capture data 102 to produce image render data 103 that can be used to more accurately reproduce the original scene light 101 on the image display device 130 (e.g., given the format of the image capture data 102 and the capabilities and/or limitations of the image display device 130). More specifically, the image processing performed by the DCM circuit 120 may bridge the image capture capabilities of the image capture device 110 and the image display capabilities of the image display device 130. In some aspects, the DCM circuit 120 may convert between various imaging formats such as HLG to HDR10, HDR10 to HLG, SDR to HDR, and/or SDR to HDR. In some embodiments, the DCM 120 may be incorporated in the image capture device 110 and/or the image display device 130.

The image display device 130 includes a decoder 132, a CSC 134, an electro-optical transfer function (EOTF) 136, and a display 138. The decoder 132 receives the image render data 103 from the DCM 120 and decodes the received data to recover YUV image data (YUV_{D}). For example, the decoder 132 may decode the image render data 103 using the same (or similar) data compression and/or signal modulation techniques implemented by the encoder 118 of the image capture device 110.

The CSC 134 changes the color space of the YUV image data YUV_{D}. It is noted that, while the YUV color space may be more conducive to image processing, the RGB color model is widely used for rendering and displaying images on image display devices. Thus, in some implementations, the CSC 116 may convert the YUV image data YUV_{D} from the YUV color space back to an RGB color space (e.g., as converted RGB image data RGB_{D}). For example, the converted RGB image data RGB D may describe the red, green, and blue color components (e.g., brightness levels) of each pixel of the display 138.

The EOTF 136 characterizes the converted RGB image data RGB D to corresponding electrical signals (ED) that can be used to illuminate the pixels of the display 138. In some aspects, the EOTF 136 may transfer RGB information from the digital to analog domain. For example, the EOTF 136 may convert the digital RGB image data RGB D to analog brightness values (e.g., nits) associated with the display 138.

The display 138 converts the electrical signals ED to the display light 104. For example, the display 138 may include an array of display pixel elements each configured to display a respective pixel of the corresponding image (e.g., using CRT, LCD, or OLED technologies). More specifically, the color and brightness of light output by each display pixel element may be defined by the electrical signals ED.

In one or more embodiments, the OETF 114 of the image capture device 110 converts the electrical signal Ec to a non-linear signal. In other embodiments, the DCM circuit 120 may include an inverse-OETF (IOETF) 122 to convert the image capture data 102 to a linear signal so that at least some of the image processing can be performed in the linear domain rather than the non-linear domain. In some aspects, the IOETF 122 may be an inverse of the OETF 114 implemented by the image capture device 110. In some embodiments, the DCM circuit 120 may include an electrical-to-electrical transfer function (EETF) 123 to perform image processing on the linear signal. For example, the image processing may ensure that the scene light 101 acquired by the image capture device 110 can be reproduced as accurately as possible via the display light 104 of the image display device 130. The DCM circuit 120 may include an inverse-EOTF (IEOTF) 124 to convert the image render data 103 back to a non-linear signal. In some aspects, the IEOTF 124 may be an inverse of the EOTF 136 implemented by the image display device 130.

It is noted that the OETF 114 and EOTF 136 operate in the RGB domain. In some embodiments, the OETF 114 may transfer RGB information from the analog to digital domain whereas the EOTF 136 may transfer RGB information from the digital to analog domain. In such embodiments, the IOETF 122 and IEOTF 124 may also operate in the RGB domain, and the output of the IOETF 122 (on which image processing is performed) and the input of the IEOTF 124 may comprise linear signals in an RGB color space.

In some embodiments, color-space remapping techniques may be used to remap the color space of the image capture device 110 to accommodate the color space or gamut of the image display device 130. When making adjustments in the RGB domain, the individual red, green, and blue color values affect both the color and brightness of each pixel. Changing the intensity of only one of the RGB values (e.g., red) will alter not only the color but also the brightness of a given pixel.

In contrast, YUV component values define each pixel in terms of its luminance (e.g., brightness) and chrominance (e.g., color). Changing the luminance (Y) value alters the brightness of the pixel without affecting its color. Further, the chrominance (UV) values define the color of each pixel in terms of a difference in red (U) relative to green and blue or a difference in blue (V) relative to green and red. Because YUV values do not define an absolute color space, the YUV values may represent a significantly wider range of colors and/or brightness levels (e.g., color gamut) than RGB values.

In some embodiments, the EETF 123 may be configured to perform image processing operations such as color-space remapping in the YUV domain. For example, the EETF 123 may convert the linear signal output by the IOETF 122 to a YUV color space prior to image processing. The EETF 123 may then perform image processing on the linear signal (e.g., image data) in the YUV domain. The EETF 123 may further convert the processed signal back to an RGB color space to be input to the IEOTF 124.

In some embodiments, the DCM 120 may be provided with additional information about the image capture data 102 (e.g., metadata). For example, the metadata may be based on a range and/or distribution of luminance values in one or more images or video frames associated with the image capture data 102. The range of luminance values may indicate whether the received image capture data 102 contains full-range color information (e.g., color values from 0-255) or narrow-range color information (e.g., color values from 16-235). Such information may be helpful in determining the appropriate mappings between a color space of the image capture device 110 and a color space of the image display device 130. For example, some colors may be clipped if the image capture data 102 contains full-range data while the DCM 120 expects to receive narrow-range data from the image capture device 110 and attempts to re-scale the image capture data 102 to full-range for display.

Aspects of the present disclosure recognize that some image capture devices, and other sources of media content, may not provide metadata along with image capture data (e.g., depending on the imaging techniques and/or standards being used). In some embodiments, the DCM 120 may be configured to generate metadata locally based, at least in part, on the received image capture data 102. For example, the DCM 120 may analyze the incoming image capture data 102 to determine a range and/or distribution of luminance values in each of one or more images or video frames. In some aspects, the DCM 120 may further use the metadata to program one or more registers and/or lookup tables (LUTs) to be used in image processing. For example, the DCM 120 may use the luminance information to determine the appropriate mappings between a color space of the image capture device 110 and a color space of the image display device 130.

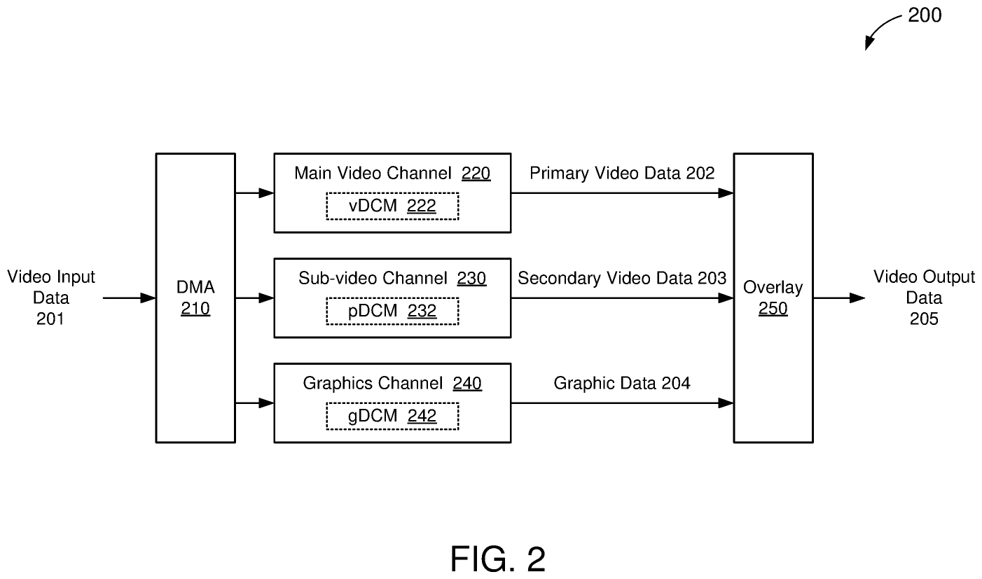

FIG. 2 shows a block diagram of a video post-processing (VPP) pipeline 200 that may be used to transfer images from different image capture devices with different system capabilities and standards to an image display device, in accordance with some embodiments. The VPP pipeline 200 includes a direct media access (DMA) controller 210, a main video channel 220, a sub-video channel 230, a graphics channel 240, and an overlay module 250. The VPP pipeline 200 may receive one or more incoming video signals from an image capture device, such as the image capture device 110 of FIG. 1, and process the received video signals for presentation on a display device, such as the image display device 130 of FIG. 1.

The DMA 210 may receive video input data 201 from various sources (e.g., image capture devices) and redistribute the video input data 201 to one or more of the channels 220-240. For example, if the video input data 201 corresponds to a primary video feed (e.g., from a first source device), the DMA 210 may forward the video input data 201 to the main video channel 220. If the video input data 201 corresponds to a secondary video feed (e.g., from a second source device), the DMA 210 may forward the video input data 201 to the sub-video channel 230. If the video input data 201 corresponds to a graphic (e.g., from a third source device), the DMA 210 may forward the video input data 201 to the graphics channel 240.

The main video channel 220 processes the video input data 201 to generate primary video data 202 for display on a corresponding image display device. The primary video data 202 may correspond to a primary video feed to be presented prominently on the image display device, for example, by occupying most (if not all) of the display area. Accordingly, the main video channel 220 may perform the greatest amount of post-processing on the video input data 201 (e.g., more than the sub-video channel 230 and the graphics channel 240) to ensure that the primary video data 202 can be reproduced as accurately as possible, with minimal noise and/or artifacts. In some embodiments, the main video channel 220 may include a video DCM (vDCM) 222 to perform data conversion and color space mapping on the primary video feed. It is noted that low-resolution SDR images may undergo high-quality video processing by the vDCM 222, such as cleaning noise and converting to HDR gamut.

The sub-video channel 230 processes the video input data 201 to generate secondary video data 203 for display on the corresponding image display device. The secondary video data 203 may correspond to a secondary video feed to be presented, concurrently with the primary video feed, in a relatively small display region (e.g., in a picture-in-picture or PIP format) of the image display device. Since the secondary video feed may occupy a substantially smaller display region than the primary video feed, the sub-video channel 230 may perform less post-processing than the main video channel 220 (e.g., but more post-processing than the graphics channel 240) in generating the secondary video data 203. In some embodiments, the sub-video channel 230 may include a picture-in-picture DCM (pDCM) 232 to perform data conversion and color space mapping on the secondary video feed.

The graphics channel 240 processes the video input data 201 to generate graphic data 204 for display on the corresponding image display device. The graphic data 204 may correspond to one or more graphics to be presented, concurrently with the primary video feed and/or the secondary video feed, in a portion of the image display device (e.g., as a HUD or overlay). Since the graphics may not contain detailed image or video content, the graphics channel 240 may perform the least amount of post-processing (e.g., less than the main video channel 220 and the sub-video channel 230) in generating the graphic data 204. In some embodiments, the graphics channel 240 may include a graphic DCM (gDCM) 242 to perform data conversion and color space mapping on the graphics.

The overlay module 250 may combine the primary video data 202 with at least one of the secondary video data 203 and/or the graphic data 204 to produce video output data 205 corresponding to a combined video feed that is optimized for display on the image display device. For example, each frame of the combined video feed may include a single frame of the primary video feed and a single frame of the secondary video feed and/or a graphic to be displayed with the frame of the primary video feed. In some embodiments, the overlay module 250 may render the secondary video data 203 and/or the graphic data 204 for display as an overlay that covers at least a portion of the primary video feed 202. Thus, when the image display device renders the video output data 205, at least some of the pixels will display a portion of the primary video feed and at least some of the pixels will display the secondary video feed and/or the graphic overlay.

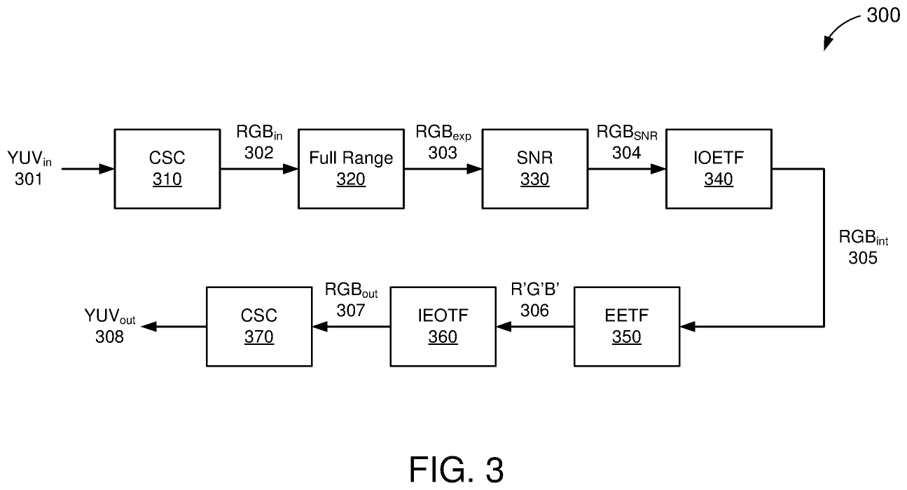

FIG. 3 shows a block diagram of a DCM circuit 300, in accordance with some embodiments. In some embodiments, the DCM circuit 300 may be implemented in the main video channel of a VPP pipeline such as the main video channel 220 of FIG. 2. The DCM circuit 300 may be an example embodiment of the vDCM module 222 of FIG. 2.

In some aspects, the DCM circuit 300 may be configured to perform image processing operations (e.g., data conversion and color space mapping) on a primary video feed. The DCM circuit 300 may include any of the image and/or video processing functionality of the other video paths of the VPP pipeline (e.g., the sub-video channel 230 and/or the graphics channel 240 of FIG. 2) and may support different input and output video format conversion. For example, the DCM circuit 300 may translate image data from a color space associated with an image capture device to a color space supported by an image display device. The DCM circuit 300 includes a first color-space converter (CSC) 310, a full-range expander 320, a spatial noise reducer (SNR) 330, an IOETF 340, an EETF 350, an IEOTF 360, and a second CSC 370.

The first CSC 310 receives YUV input data (YUVᵢₙ) 301 and converts the YUV input data 301, from a YUV color space to an RGB color space, to produce corresponding RGB input data (RGBᵢₙ) 302. The YUV color space defines a gamut of the image capture device in terms of YUV components. The RGB color space defines a gamut of the image capture device in terms of RGB components. In some embodiments, the first CSC 310 may perform the color-space conversion in a 12-bit domain, for example, by converting 12-bit YUV data to 12-bit RGB data. For example, the YUV input data 301 may correspond to a 10-bit YUV value in a 444 format that is scaled by 4 times to become a 12-bit input. In some embodiments, the first CSC 310 may be a generic and full-size color space converter having 3×3 matrix-style multipliers with 9 programmable matrix coefficients, 3 adders for offset adjustments with 3 programmable offset corrections, and 3 output clamping logics to generate the 12-bit RGB data 302.

The full-range expander 320 expands the maximum range of the RGB input data 302 to produce expanded RGB data (RGBₑₓₚ) 303. For example, the range of digital YUV data may be limited between an artificial minimum (“min”) and an artificial maximum (“max”) in order to reserve some codes for timing reference purposes. Thus, if the original YUV source data has been limited (e.g., from 256 to 3760 in the 12-bit range), then a full-range expansion may be applied to force the RGB data 303 to fall within a predetermined maximum range (e.g., between 0 and 4095) of the RGB color space. When the YUV input data 301 is converted to the RGB color space, the range of the RGB input data 302 may remain the same. Thus, each of the RGB signals may be expanded using only a limited set of parameters. In some aspects, two additional parameters (e.g., “off” and “gain”) may be used to manipulate the full-range expansion:

$$off = \frac{min + max}{2} \\ gain = \frac{4095}{max - min} \\ Full Range = Clamp ( ( Clamp ( RGB , Min , Max ) - off ) \times gain ) + off , 0 , 4095 )$$

The SNR 330 reduces quantization noise in the expanded RGB data 303 to produce filtered RGB data (RGB_{SNR}) 304. For example, compressed video data may be noisy due to quantization error. An 8- or 10-bit SDR input, when displayed on a 12-bit television or monitor, may exhibit strong quantization-related contouring or artifacts due to the brightness leverage of the HDR display. In some embodiments, the SNR 330 may adaptively apply (or remove) low-pass filtering to individual portions of the expanded RGB data 303 to reduce quantization noise in flat or low-transition regions of the image associated with the expanded RGB data 303. In some implementations, the SNR 330 may use a mean and deviation of the 3×3 input kennel to blend original data with average data using a deviation from its center data. An area of interest selection logic may be generated and used to multiplex the RGB data output (e.g., to produce the filtered RGB data 303).

The IOETF 340 converts the filtered RGB data 304 to a linearly-interpolated signal (RGBᵢₙₜ) 305 so that image processing operations such as color-space re-mapping can be performed in a more precisely linear domain. The input data 301 to the DCM circuit 300 may be in a non-linear domain (e.g., due to an OETF applied at the source). In some embodiments, the IOETF 340 may implement an inverse of the OETF to convert the filtered RGB data 304 back to its original linear domain so that the image processing can be performed on the substantially linear signal.

The EETF 350 bridges the color-space at the source (e.g., camera or image capture device) and the color-space at the output (e.g., television or image display device) by remapping the interpolated RGB data 305 to a color-space that is better suited for presentation on the display (e.g., as re-mapped RGB data 306). For example, a three-dimension color-space can be characterized by a set of values (X, Y, Z). The color-space conversion from a first RGB domain (e.g., R1G1B1) to a second RGB domain (e.g., R2G2B2) involves the following transformation:

$$[ \begin{matrix}R 2 \\ G 2 \\ B 2\end{matrix} ] = T {2}^{- 1} \times T 1 \times [ \begin{matrix}R 1 \\ G 1 \\ B 1\end{matrix} ]$$

where T is a 3×3 matrix defined as:

$$T = [ \begin{matrix}r \times x ( r ) & g \times x ( g ) & b \times x ( b ) \\ r \times y ( r ) & g \times y ( g ) & b \times y ( b ) \\ r \times z ( r ) & g \times z ( g ) & b \times z ( b )\end{matrix} ]$$

The IEOTF 360 converts the re-mapped RGB data (R′G′B′) 306 back to a non-linear output signal (RGBₒᵤₜ) 307. More specifically, the IEOTF 360 may convert the re-mapped RGB data 306 from the current linear domain back to a non-linear domain that can be interpreted by an image display device. Thus, in some embodiments, the IEOTF 360 may implement an inverse of the EOTF to convert the re-mapped RGB data 306 back to its previous non-linear domain. In some instances, such as when converting from one HDR standard to another HDR standard, bypassing the EETF 350, and thus the IOETF 340 as well as the IEOTF 360, may help achieve better accuracy in computation.

The second CSC 370 receives the RGB output data 307 and converts the RGB output data 307, from an RGB color space to a YUV color space, to produce corresponding YUV output data (YUVₒᵤₜ) 308. In some embodiments, the second CSC 370 may have 12-bit input terminals (e.g., to receive 12-bit RGB values) and 12-bit output terminals (e.g., to provide 12-bit YUV values). For example, the YUV output data 308 may correspond to a 10-bit YUV value in a 444 format that is shifted by 2 bits to become a 12-bit input. In some embodiments, the second CSC 370 may be a generic and full-size color space converter having 3×3 matrix-style multipliers with 9 programmable coefficients, 3 adders for programmable offset adjustments, and 3 output clamping logics to generate the 12-bit YUV data 308.

In some embodiments, with reference to the EETF 350, the transformation from the first RGB domain (e.g., R1G1B1) to the second RGB domain (e.g., R2G2B2) assumes that the relative luminance (Y) is not changed and normalized. In some embodiments, if there is a change in luminance, such as when converting from SDR format to HDR format, the EETF 350 may additionally perform a color-volume mapping. This change may not be global. For example, color-volume mapping may be performed in a local domain using a three-dimensional lookup table (e.g., in RGB domain) or a two-dimensional lookup table (e.g., in YUV domain). In some embodiments, the EETF 350 may perform the color-volume mapping by first converting the RGB data to the YUV domain, applying a color-volume mapping function using LSH (e.g., “lightness,” “saturation,” and “hue”) manipulation, and finally converting the YUV data back to the RGB domain as re-mapped RGB data (R′G′B′) 306.

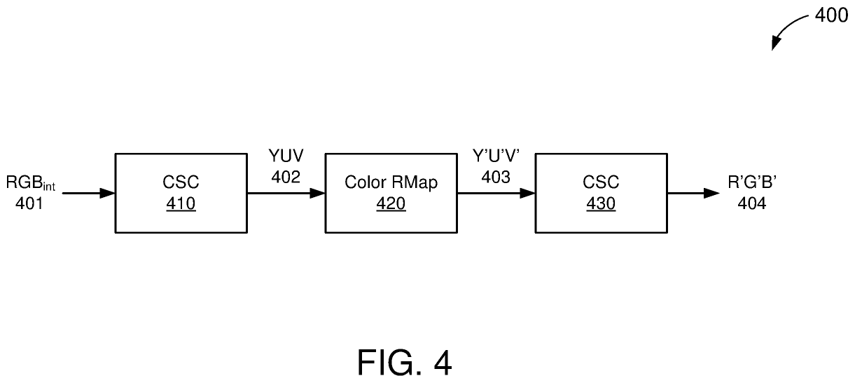

FIG. 4 shows a block diagram of an EETF 400, in accordance with some embodiments. The EETF 400 may be an example embodiment of the EETF 350 of FIG. 3. The EETF 400 may be configured to perform image processing operations such as, for example, color-space re-mapping. In some implementations, the EETF 400 may receive interpolated RGB data (RGBᵢₙₜ) 401 as its input and generate re-mapped RGB data (R′G′B′) 404 at its output. In some embodiments, the EETF 400 may perform image processing on the received RGB data 401 in the YUV color space.

The EETF 400 includes a first CSC 410, a color-space re-mapper (Color RMap) 420, and a second CSC 430. The first CSC 410 converts the interpolated RGB data 401, from an RGB color space to a YUV color space, to produce corresponding YUV image data 402. For example, the interpolated RGB data 401 may correspond to a linearly-interpolated signal, such as RGBᵢₙₜ 305, that is based, at least in part, on the OETF of an image capture device. Thus, in some aspects, the YUV image data 402 may also correspond to a substantially linear signal.

The color-space re-mapper 420 re-maps the YUV image data 402 from the YUV color space of the image capture device to a YUV color space supported by the image display device based on a gamut of the image display device. In some aspects, the color-space re-mapper may perform color mapping based on LSH manipulations. For example, in the UV domain (e.g., representing H and S), a given input color p(U,V) may be mapped to an output color p′(U′,V′) through a hue angle rotation and saturation radius gain. The UV values may be converted into an “s” value, where:

$$s = \sqrt{{U}^{2} + {V}^{2}}$$

A two-dimensional interpolator (e.g., using a 17×17×30 bit lookup table) may combine the s value with the Y input to produce local LSH values. After applying a global LSH adjustment to the local LSH values, re-mapped YUV values (Y′U′V′) 403 may be generated based, at least in part, on the area of interest.

The second CSC 430 converts the re-mapped YUV values 403, from the YUV color space back to an RGB color space, to produce the re-mapped RGB data 404. Some image display devices may be configured to operate using the RGB color model. In some embodiments, color-space re-mapping may be performed more efficiently and/or accurately in the YUV domain. In some embodiments, the re-mapped image data (e.g., re-mapped YUV values 403) may be converted back to the RGB domain for display. For example, the re-mapped RGB data 404 may correspond to a linearly-interpolated signal, such as R′G′B′ 306, that is based, at least in part, on the EOTF of the image display device.

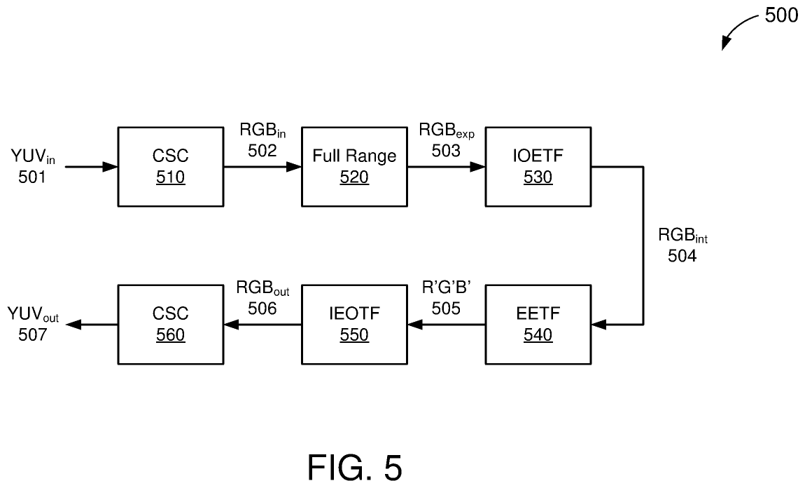

FIG. 5 shows another block diagram of a DCM circuit 500, in accordance with some embodiments. In some embodiments, the DCM circuit 500 may be implemented in a sub-video channel of a VPP pipeline such as the sub-video channel 230 of FIG. 2. Thus, the DCM circuit 500 may be an example embodiment of the pDCM module 232 of FIG. 2.

In some aspects, the DCM circuit 500 may be configured to perform image processing (e.g., data conversion and color space mapping) on a secondary video feed to be presented concurrently (e.g., as a PIP) with a primary video feed. For example, the DCM circuit 400 may translate image data from a color space associated with an image capture device to a color space supported by an image display device. The DCM circuit 500 may include most (if not all) of the image and/or video processing functionality of the main video path of the VPP pipeline (e.g., the main video channel 220 of FIG. 2 and/or DCM 300 of FIG. 3) with the exception of the SNR block (e.g., SNR 330). For example, the DCM circuit 500 may include a first CSC 510, a full-range expander 520, an IOETF 530, an EETF 540, an IEOTF 550, and a second CSC 560.

The first CSC 510 receives YUV input data (YUVᵢₙ) 501 and converts the YUV input data 501, from a YUV color space to an RGB color space, to produce corresponding RGB input data (RGBᵢₙ) 502. In some embodiments, the first CSC 510 may have 12-bit input terminals to receive 12-bit YUV values and 12-bit output terminals to provide 12-bit RGB values. For example, the YUV input data 501 may correspond to a 10-bit YUV value in a 444 format that is left shifted by 2 bits to become a 12-bit input. In some embodiments, the first CSC 510 may be a generic and full-size color space converter having 3×3 matrix-style multipliers with 9 programmable coefficients, 3 adders for offset adjustments with 3 programmable offsets, and 3 output clamping logics to generate the RGB data 502.

The full-range expander 520 expands the maximum range of the RGB input data 502 to produce expanded RGB data (RGBₑₓₚ) 503. For example, if the original YUV source data has been limited (e.g., from 256 to 3760 in the 12-bit range), then a full-range expansion may be applied to force the RGB data 503 to fall within a predetermined maximum range (e.g., between 0 and 4095) of the RGB color space. When the YUV input data 501 is converted to the RGB color space, the range of the RGB input data 502 may remain the same. Thus, each of the RGB signals may be expanded using only a limited set of parameters. In some aspects, two additional parameters may be used to manipulate the full-range expansion (e.g., as described above with respect to FIG. 3).

The IOETF 530 converts the expanded RGB data 503 to a linearly-interpolated signal (RGBᵢₙₜ) 504 so that image processing operations, such as color-space re-mapping, can be performed on substantially linear signal in a more precisely linear domain. In some embodiments, the IOETF 530 may implement an inverse of the OETF (implemented by the image capture device) to convert the expanded RGB data 503 back to its original linear domain.

The EETF 540 bridges the color-space at the source and the color-space at the output by remapping the interpolated RGB data 504 to a color-space that is better suited for presentation on the display, as re-mapped RGB data 505. The color-space re-mapping function of the EETF 540 may be similar (if not identical) to the color-space re-mapping function performed by the EETF 350 of FIG. 3 and/or EETF 400 of FIG. 4. In some embodiments, the EETF 540 may perform color-volume mapping by first converting the RGB data 504 to the YUV domain, applying a color-volume mapping function using LSH manipulation, and then converting the YUV data back to the RGB domain as re-mapped RGB data (R′G′B′) 505 (e.g., as described above with respect to FIG. 4).

The IEOTF 550 converts the re-mapped RGB data 505 back to a non-linear output signal (RGBₒᵤₜ) 506. More specifically, the IEOTF 550 may convert the re-mapped RGB data 505 from the current linear domain back to a non-linear domain that can be interpreted by an image display device. In some embodiments, the IEOTF 550 may implement an inverse of the EOTF to convert the re-mapped RGB data 505 back to its previous non-linear domain. In some instances, bypassing the EETF 540, and thus the IOETF 530 as well as the IEOTF 550, may help achieve better accuracy in computation.

The second CSC 560 receives the RGB output data 506 and converts the RGB output data 506, from an RGB color space to a YUV color space, to produce corresponding YUV output data (YUVₒᵤₜ) 507. In some embodiments, the second CSC 560 may have 12-bit input terminals to receive 12-bit RGB values and 12-bit output terminals to provide 12-bit YUV values. For example, the YUV output data 507 may correspond to a 10-bit YUV value in a 444 format that is left shifted by 2 bits to become a 12-bit input. In some embodiments, the second CSC 560 may be a generic and full-size color space converter having 3×3 matrix-style multipliers with 9 programmable coefficients, 3 adders for offset adjustments with 3 programmable offsets, and 3 output clamping logics to generate the YUV data 507.

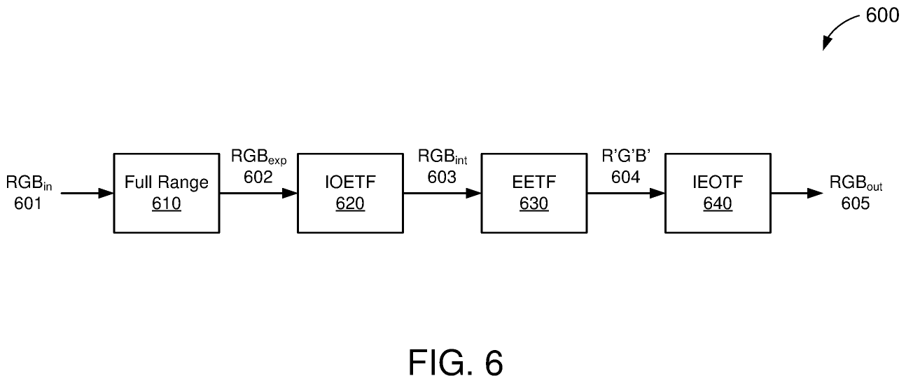

FIG. 6 shows another block diagram of a DCM circuit 600, in accordance with some embodiments. In some embodiments, the DCM circuit 600 may be implemented in a graphics channel of a VPP pipeline such as the graphics channel 240 of FIG. 2. In some other embodiments, the DCM circuit 600 may be implemented in a sub-video channel of a VPP pipeline such as the sub-video channel 230 of FIG. 2. Thus, the DCM circuit 600 may be an example embodiment of the gDCM module 242 and/or pDCM module 232 of FIG. 2.

In some aspects, the DCM circuit 600 may be configured to perform image processing, such as data conversion and color space mapping, on graphic data to be overlaid upon a primary video feed. In some other aspects, the DCM circuit 600 may be configured to perform data conversion and color space mapping on a secondary video feed to be presented concurrently (e.g., as a PIP) with a primary video feed. For example, when the DCM circuit 600 is implemented in a sub-video channel, color-space conversion of the secondary video feed may be performed outside the DCM 600. The DCM circuit 600 may include a subset of the image and/or video processing functionality of the main video path of the VPP pipeline (e.g., the main video channel 220 of FIG. 2 and/or DCM 300 of FIG. 3). More specifically, the DCM circuit 600 includes a full-range expander 610, an IOETF 620, an EETF 630, and an IEOTF 640.

The full-range expander 610 receives RGB input data 601 and expands the maximum range of the RGB input data 601 to produce expanded RGB data (RGBₑₓₚ) 602. For example, if the original RGB source data has been limited (e.g., from 256 to 3760 in the 12-bit range), then a full-range expansion may be applied to force the RGB data 602 to fall within a predetermined maximum range (e.g., between 0 and 4095) of the RGB color space. In some embodiments, two additional parameters may be used to manipulate the full-range expansion (e.g., as described above with respect to FIG. 3).

The IOETF 620 converts the expanded RGB data 602 to a linearly-interpolated signal (RGBᵢₙₜ) 603 so that a color-space re-mapping can be performed on a substantially linear signal in a more precisely linear domain. In some embodiments, the IOETF 620 may implement an inverse of the OETF (implemented by the image capture device) to convert the expanded RGB data 602 back to its original linear domain.

The EETF 630 bridges the color-space at the source and the color-space at the output by remapping the interpolated RGB data 603 to a color-space that is better suited for presentation on the display. The color-space re-mapping function of the EETF 630 may be similar (if not identical) to the color-space re-mapping function performed by the EETF 350 of FIG. 3 and/or EETF 400 of FIG. 4. In some embodiments, the EETF 630 may perform color-volume mapping by first converting the RGB data 603 to the YUV domain, applying a color-volume mapping function using LSH (Lightness, Saturation, Hue) manipulation, and then converting the YUV data back to the RGB domain as re-mapped RGB data (R′G′B′) 604 (e.g., as described above with respect to FIG. 4).

The IEOTF 640 converts the re-mapped RGB data 604 back to a non-linear output signal (RGBₒᵤₜ) 605. More specifically, the IEOTF 640 may convert the re-mapped RGB data 604 from the current linear domain back to a non-linear domain that can be interpreted by an image display device. In some embodiments, the IEOTF 640 may implement an inverse of the EOTF to convert the re-mapped RGB data 604 back to its previous non-linear domain. In some instances, bypassing the EETF 630, and thus the IOETF 620 as well as the IEOTF 640, may help achieve better accuracy in computation.

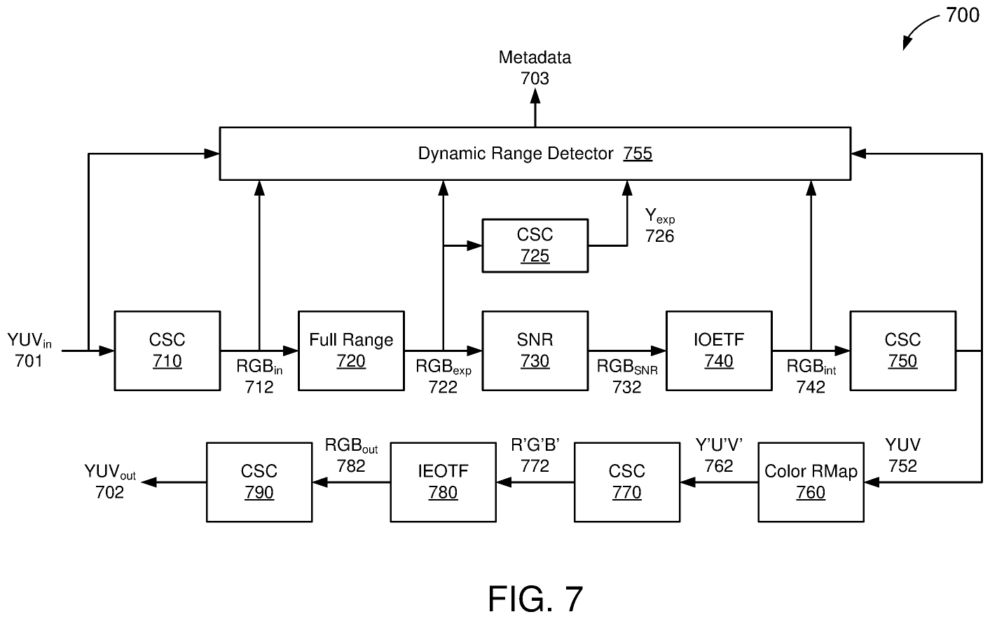

FIG. 7 shows a block diagram of a DCM circuit 700 with dynamic range detection, in accordance with some embodiments. In some embodiments, the DCM circuit 700 may be implemented in the main video channel of a VPP pipeline such as the main video channel 220 of FIG. 2. Thus, the DCM circuit 700 may be an example embodiment of the vDCM module 222 of FIG. 2. The DCM circuit 700 includes a first CSC 710, a full-range expander 720, a second CSC 725, an SNR 730, an IOETF 740, a third CSC 750, a dynamic range detector 755, a color-space re-mapper 760, a fourth CSC 770, an IEOTF 780, a fifth CSC 790.

The first CSC 710 receives YUV input data 701 and converts the YUV input data 701, from a YUV color space to an RGB color space, to produce corresponding RGB input data 712. The full-range expander 720 expands the maximum range of the RGB input data 712 to produce expanded RGB data 722. The SNR 730 reduces quantization noise in the expanded RGB data 722 to produce filtered RGB data 732. The IOETF 740 converts the filtered RGB data 732 to a linearly-interpolated signal 742 so that image processing operations, such as color-space re-mapping, can be performed on a substantially linear signal in a more precisely linear domain.

The third CSC 750 converts the interpolated RGB data 742, from an RGB color space to a YUV color space, to produce corresponding YUV image data 752. The color-space re-mapper 760 re-maps the YUV image data 752, from the YUV color space of the image capture device to a YUV color space supported by the image display device, to produce re-mapped YUV values 762. The fourth CSC 770 converts the re-mapped YUV values 762, from the YUV color space back to an RGB color space, to produce re-mapped RGB data 772. The IEOTF 780 converts the re-mapped RGB data 772 back to a non-linear output signal 782. The fifth CSC 790 receives the RGB output data 782 and converts the RGB output data 782, from an RGB color space to a YUV color space, to produce corresponding YUV output data 702.

In some embodiments, the dynamic range detector 755 may generate metadata 703 based, at least in part, on the received input data 701. For example, the metadata 703 may provide supplemental information about the characteristics and/or properties of the received input data 701 and/or the image source (e.g., image capture device). Example metadata 703 may include, but is not limited to, a data range of the received input data 701 including whether the input data 701 contains full-range color information or narrow-range color information. In some aspects, the dynamic range detector 755 may generate the metadata 703 based on the YUV input data 701, the RGB input data 712, the expanded RGB data 722, expanded YUV data 726, the interpolated RGB data 742, and/or the interpolated YUV data 752. For example, the second CSC 725 may generate the expanded YUV data 726 by converting the expanded RGB data 722 from the RGB color space to a YUV color space associated with the image capture device.

In some other embodiments, the metadata 703 may be used to dynamically adjust one or more parameters of the DCM circuit 700. For example, when converting the received input data 701 to a format more suitable for display on a corresponding display device, it may be desirable to know whether the input data 701 contains full-range data or narrow-range data. For example, some colors may be clipped if the input data 701 contains full-range data while the DCM circuit 700 expects to receive narrow-range data. If the input data 701 contains narrow-range data while the DCM circuit 700 expects to receive full-range data, the resulting image may contain lifted blacks and reduced whites.

In some embodiments, the DCM circuit 700 may use the metadata 703 to dynamically adjust one or more registers and/or lookup tables (LUTs) to be used in one or more image processing operations. For example, the metadata 703 may be used to adjust the parameters of one or more registers and/or LUTs used by any processing components of the DCM circuit 700 including, but not limited to: the first CSC 710, the full-range expander 720, the SNR 730, the third CSC 750, the color-space re-mapper 760, the fourth CSC 770, and/or the fifth CSC 790.

In some aspects, the DCM circuit 700 may dynamically generate the metadata 703 (e.g., on a per-frame basis). The characteristics and/or properties of the input data 701 may vary frame-by-frame. For example, one frame may be significantly darker (or lighter) than another frame. By dynamically generating the metadata 703, the DCM circuit 700 may adapt its image processing operations, by dynamically programming and reprogramming its registers and/or LUTs for each frame of input data 701, to accommodate any variations in the input data 701. In other words, each frame of input data 701 may be individually converted to a corresponding frame of output data 702 using image processing parameters that are well-suited or optimized for the given frame.

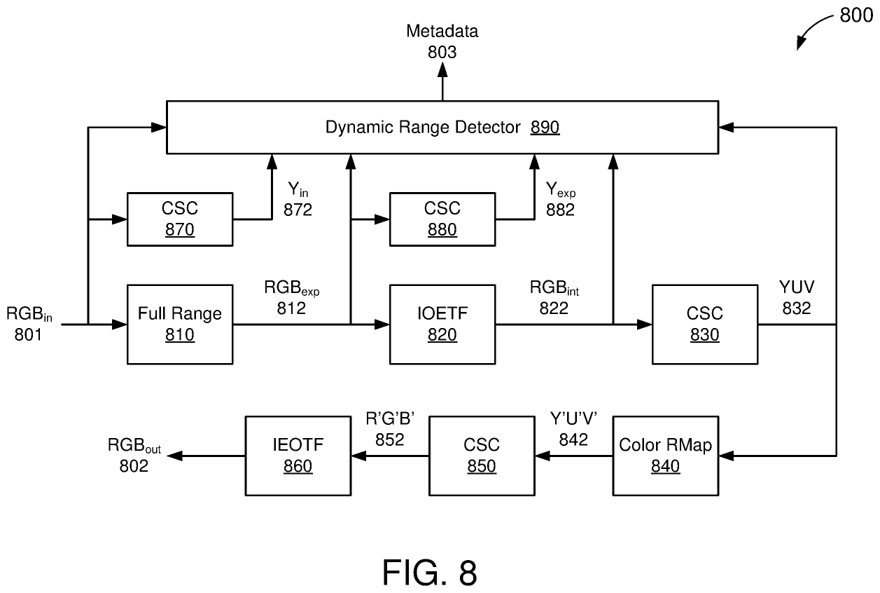

FIG. 8 shows another block diagram of a DCM circuit 800 with dynamic range detection, in accordance with some embodiments. In some embodiments, the DCM circuit 800 may be implemented in a sub-video channel of a VPP pipeline such as the sub-video channel 230 of FIG. 2. In some other embodiments, the DCM circuit 800 may be implemented in a graphics channel of a VPP pipeline such as the graphics channel 240 of FIG. 2. Thus, the DCM circuit 800 may be an example embodiment of the pDCM module 232 and/or gDCM module 242 of FIG. 2. The DCM circuit 800 includes a full-range expander 810, an IOETF 820, a first CSC 830, a color-space re-mapper 840, a second CSC 850, an IEOTF 860, third CSC 870, a fourth CSC 880, and a dynamic range detector 890.

The full range expander 810 receives RGB input data 801 and expands the maximum range of the RGB input data 801 to produce expanded RGB data 812. The IOETF 820 converts the expanded RGB data 812 to a linearly-interpolated signal 822. The first CSC 830 converts the interpolated RGB data 822, from an RGB color space to a YUV color space, to produce corresponding YUV image data 832. The color-space re-mapper 840 re-maps the YUV image data 832, from the YUV color space of the image capture device to a YUV color space supported by the image display device, to produce re-mapped YUV values 842. The second CSC 850 converts the re-mapped YUV values 842, from the YUV color space back to an RGB color space, to produce re-mapped RGB data 852. The IEOTF 780 converts the re-mapped RGB data 852 back to a non-linear output signal 802.

In some embodiments, the dynamic range detector 890 may generate metadata 803 based, at least in part, on the received input data 801. For example, the metadata 803 may provide supplemental information about the characteristics and/or properties of the received input data 801 and/or the image source. Example metadata 803 may include, but is not limited to, a data range of the received input data 801. In some aspects, the dynamic range detector 890 may generate the metadata 803 based on the RGB input data 801, YUV input data 872, the expanded RGB data 812, expanded YUV data 882, the interpolated RGB data 822, and/or the interpolated YUV data 832. For example, the third CSC 870 may generate the YUV input data 872 by converting the RGB input data 801 from the RGB color space to a YUV color space associated with the image capture device, and the fourth CSC 880 may generate the expanded YUV data 882 by converting the expanded RGB data 812 from the RGB color space to a YUV color space associated with the image capture device.

In some other embodiments, the metadata 803 may be used to dynamically adjust one or more parameters of the DCM circuit 800. More specifically, in some aspects, the DCM circuit 800 may use the metadata 803 to dynamically adjust one or more registers and/or lookup tables (LUTs) to be used in one or more image processing operations. For example, the metadata 803 may be used to adjust the parameters of one or more registers and/or LUTs used by any processing components of the DCM circuit 800 including, but not limited to: the full-range expander 810, the first CSC 830, the color-space re-mapper 840, and/or the second CSC 850. In some aspects, the DCM circuit 800 may dynamically generate the metadata 803 (e.g., on a per-frame basis). For example, by dynamically generating the metadata 803, the DCM circuit 800 may adapt its image processing operations, by dynamically programming and reprogramming its registers and/or LUTs for each frame of input data 801, to accommodate any variations in the input data 801.

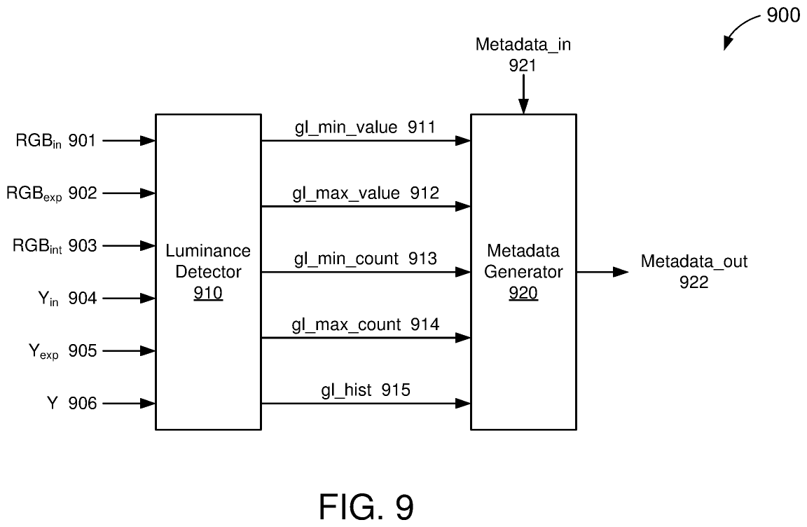

FIG. 9 shows a block diagram of a dynamic range detector 900, in accordance with some embodiments. The dynamic range detector 900 may be an example embodiment of the dynamic range detector 755 of FIG. 7 and/or the dynamic range detector 890 of FIG. 8. Thus, the dynamic range detector 900 may be configured to generate output metadata (metadata_out) 922 based, at least in part, on input data received from an image capture device or other image source. The dynamic range detector 900 includes a luminance detector 910 and a metadata generator 920.

In some aspects, the luminance detector 910 may receive, as inputs, RGB input data 901, expanded RGB data 902, interpolated RGB data 903, luminance (Y) input data 904, expanded luminance data 905, and/or interpolated luminance data 906. For example, the RGB input data 901 may be provided directly by the image capture device or image source (e.g., as RGBᵢₙ 801 of FIG. 8) or by a color-space converter of a corresponding DCM circuit (e.g., CSC 710 of FIG. 7). The expanded RGB data 902 may be provided by a full range expander of the DCM circuit (e.g., full range expander 720 and/or 810). The interpolated RGB data 903 may be provided by an IOETF of the DCM circuit (e.g., IOETF 740 and/or 820).

Further, the luminance input data 904 may be provided directly by the image capture device or image source (e.g., as YUVᵢₙ 701) or by a color-space converter of the DCM circuit (e.g., CSC 870). The expanded luminance data 905 may be provided by a color-space converter of the DCM circuit (e.g., CSC 725 and/or 880). The interpolated luminance data 906 may be provided by another color-space converter of the DCM circuit (e.g., CSC 750 and/or CSC 830).

In some embodiments, the luminance detector 910 may determine a minimum luminance value (gl_min_value) 911 and a maximum luminance value (gl_max_value) 912 within a given frame or image based on the RGB input data 901 or the luminance input data 904. For example, the minimum luminance value 911 may correspond to a luminance value of the darkest pixel in the given frame. Similarly, the maximum luminance value 912 may correspond to a luminance value of the brightest pixel in the given frame.

In some other embodiments, the luminance detector 910 may further determine a frequency of the minimum luminance value (gl_min_count) 913 and a frequency of the maximum luminance value (gl_max_count) 914 based on the RGB input data 901 or the luminance input data 904. For example, the minimum luminance frequency 913 may correspond to the number of pixels, in the given frame, having the minimum luminance value 911. Similarly, the maximum luminance frequency 914 may correspond to the number of pixels, in the given frame, having the maximum luminance value 914.

Still further, in some embodiments, the luminance detector 910 may determine a distribution of luminance values (gl_hist) 915 within the given frame based on the processed RGB data 902 and 903 or the processed luminance data 905 and 906. For example, the luminance distribution 915 may identify each luminance value in the given frame and the frequency at which each luminance value occurs in the given frame. In some aspects, the luminance distribution 915 may be converted to a histogram indicating the various luminance values in the frame (e.g., corresponding to a first axis of the histogram) and the number of pixels in the frame associated with each luminance value (e.g., corresponding to a second axis of the histogram).

The metadata generator 920 may generate the metadata 922 based, at least in part, on the luminance information (e.g., gl_min_value 911, gl_max_value 912, gl_min_count 913, gl_max_count 914, and gl_hist 915) produced by the luminance detector 910. The metadata 922 may describe one or more characteristics and/or properties of the image data or input data received from an image capture device or other image source. In some aspects, the metadata 922 may indicate a data range of the received image data including whether the image data contains full-range color information or narrow-range color information. Aspects of the present disclosure recognize that various other information about the image data may also be included in the metadata 922.

It is noted that some imaging standards support the transmission of metadata along with image capture data, while some legacy standards do not. Because the metadata 922 is generated locally by the dynamic range detector 900 on the DCM circuit based on raw input data, the metadata 922 may be agnostic to the imaging standard that was originally used in generating the input data. Accordingly, the dynamic range detector 900 may bridge the gap between modern imaging standards and older legacy standards.

In some embodiments, the metadata generator 920 may generate the metadata 922 based, at least in part, on input metadata (metadata_in) 921 received from the image capture device or image source. For example, when input metadata 921 is available, the dynamic range detector 900 may leverage the existing metadata 921 to generate the output metadata 922. It is noted that some input metadata 921 may include dynamic metadata about each frame of input data and other input metadata 921 may include static metadata about the series of frames, as a whole). In some aspects, the dynamic range detector 900 may supplement the received input metadata 921 with dynamic metadata generated by the metadata generator 920 (e.g., based on the luminance information 911-915) in producing the output metadata 922.

In some embodiments, the metadata 922 may be used to configure and/or adjust one or more parameters of the DCM circuit. For example, the metadata 922 may be used to program or adjust one or more registers and/or LUTs used by one or more image processing resources (e.g., as described with respect to FIGS. 7 and 8). In some other embodiments, the metadata 922 may be output or otherwise provided to a display device, such as the image display device 130 of FIG. 1, to aid in the display or rendering of corresponding image render data. For example, the metadata 922 may be used to indicate to the display device whether the associated image render data contains full-frame image data or narrow-frame image data so that the display device can accurately reproduce the corresponding image.

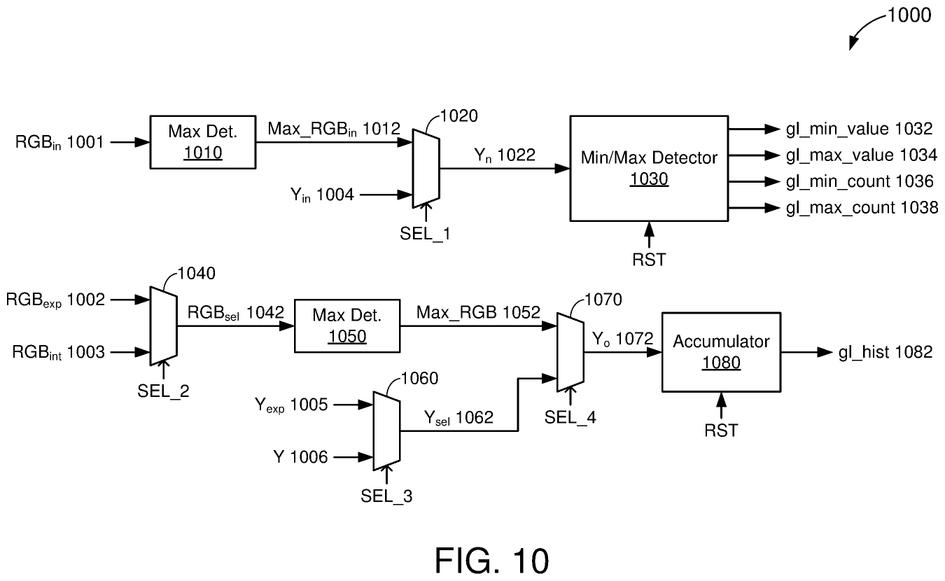

FIG. 10 shows a block diagram of a luminance detector 1000, in accordance with some embodiments. The luminance detector 1000 may be an example embodiment of the luminance detector 910 of FIG. 9. Thus, in some embodiments, the luminance detector 1000 may be configured to determine luminance information about received image data. The luminance detector 1000 includes a first maximum (max) luminance detector 1010, a first multiplexer (mux) 1020, a minimum and maximum (min/max) luminance detector 1030, a second mux 1040, a second max luminance detector 1050, a third mux 1060, a fourth mux 1070, and an accumulator 1080.

The first max luminance detector 1010 receives RGB input data 1001 and outputs a first set of RGB luminance data (max_RGBᵢₙ) 1012 based on the received RGB input data 1001. The RGB input data 1001 may be an example embodiment of the RGB input data 901 of FIG. 9. In some aspects, the max luminance detector 1010 may determine a maximum luminance value associated with each pixel of a given frame of the RGB input data 1001. For example, the max luminance detector 1010 may determine, for each pixel, whether the red, green, or blue component sub-pixel has the highest luminance value. The RGB luminance data 1012 may indicate the brightest sub-pixel (red, green, or blue) within each pixel and/or the luminance value associated with each sub-pixel.

The first mux 1020 receives the RGB luminance data 1012 and luminance input data 1004 and outputs a first set of luminance range information (Yₙ) 1022 in response to a first select signal (SEL_1). The luminance input data 1004 may be an example embodiment of the luminance input data 904 of FIG. 9. In some embodiments, the first mux 1020 may selectively output one of the RGB luminance data 1012 or the luminance input data 1004 as the luminance range information 1022 based, at least in part, on the type of metadata to be generated. For example, when generating metadata to be used in programming one or more registers and/or LUTs that operate in the RGB domain, the first mux 1020 may output the RGB luminance data 1012. On the other hand, when generating metadata to be used in programming one or more registers and/or LUTs that operate in the YUV domain, the first mux 1020 may output the luminance input data 1004.

The min/max detector 1030 determines a minimum luminance value (gl_min_value) 1032 and a maximum luminance value (gl_max_value) 1034 a frequency of the minimum luminance value (gl_min_count) 1036 and a frequency of the maximum luminance value (gl_max_count) 1038 based on the luminance range information 1022. For example, the minimum luminance value 1032 may correspond to a luminance value of the darkest pixel in the given frame, whereas the maximum luminance value 1034 may correspond to a luminance value of the brightest pixel in the given frame. Further, the minimum luminance frequency 1036 may correspond to the number of pixels, in the given frame, having the minimum luminance value 1032, whereas the maximum luminance frequency 1038 may correspond to the number of pixels, in the given frame, having the maximum luminance value 1034. In some aspects, the min/max detector 1030 may reset the luminance information 1032-1038 for each subsequent frame of received image data in response to a reset signal (RST).

The second mux 1040 receives expanded RGB data 1002 and interpolated RGB data 1003 and outputs selected RGB data (RGBₛₑₗ) 1042 in response to a second select signal (SEL_2). The expanded RGB data 1002 and interpolated RGB data 1003 may be example embodiments of the expanded RGB data 902 and interpolated RGB data 903, respectively, of FIG. 9. In some embodiments, the second mux 1040 may selectively output one of the expanded RGB data 1002 or the interpolated RGB data 1003 as the selected RGB data 1042 based, at least in part, on the type of metadata to be generated. For example, when generating metadata to be used in programming one or more registers and/or LUTs that operate in the non-linear domain, the second mux 1040 may output the expanded RGB data 1002. On the other hand, when generating metadata to be used in programming one or more registers and/or LUTs that operate in the non-linear domain, the second mux 1040 may output the interpolated RGB data 1003.

The second max luminance detector 1050 receives the selected RGB data 1042 and outputs a second set of RGB luminance data (max_RGB) 1052 based on the selected RGB data 1042. In some aspects, the max luminance detector 1050 may determine a maximum luminance value associated with each pixel of a given frame of the selected RGB data 1042. For example, the max luminance detector 1050 may determine, for each pixel, whether the red, green, or blue component sub-pixel has the highest luminance value. The RGB luminance data 1052 may indicate the brightest sub-pixel (red, green, or blue) within each pixel and/or the luminance value associated with each sub-pixel.

The third mux 1060 receives expanded luminance data 1005 and interpolated luminance data 1006 and outputs selected luminance data (Yₛₑₗ) 1062 in response to a third select signal (SEL_3). The expanded luminance data 1005 and interpolated luminance data 1006 may be example embodiments of the expanded luminance data 905 and interpolated luminance data 906, respectively, of FIG. 9. In some embodiments, the third mux 1060 may selectively output one of the expanded luminance data 1005 or the interpolated luminance data 1006 as the selected luminance data 1062 based, at least in part, on the type of metadata to be generated. For example, when generating metadata to be used in programming one or more registers and/or LUTs that operate in the non-linear domain, the third mux 1060 may output the expanded luminance data 1005. On the other hand, when generating metadata to be used in programming one or more registers and/or LUTs that operate in the non-linear domain, the third mux 1060 may output the interpolated luminance data 1006.

The fourth mux 1070 receives the RGB luminance data 1052 and the selected luminance data 1062 and outputs a second set of luminance range information (Yₒ) 1072 in response to a fourth select signal (SEL_4). In some embodiments, the fourth mux 1070 may selectively output one of the RGB luminance data 1052 or the selected luminance data 1062 as the luminance range information 1072 based, at least in part, on the type of metadata to be generated. For example, when generating metadata to be used in programming one or more registers and/or LUTs that operate in the RGB domain, the fourth mux 1070 may output the RGB luminance data 1052. On the other hand, when generating metadata to be used in programming one or more registers and/or LUTs that operate in the YUV domain, the fourth mux 070 may output the selected luminance data 1062.

The accumulator 1080 determines a distribution of luminance values (gl_hist) 1082 based on the luminance range information 1072. For example, the luminance distribution 1082 may identify each luminance value in the given frame and the frequency at which each luminance value occurs in the given frame. In some aspects, the luminance distribution 1082 may be converted to a histogram indicating the various luminance values in the frame and the number of pixels in the frame associated with each luminance value. In some aspects, the accumulator 1080 may reset the luminance distribution 1082 for each subsequent frame of received image data in response to the reset signal RST.

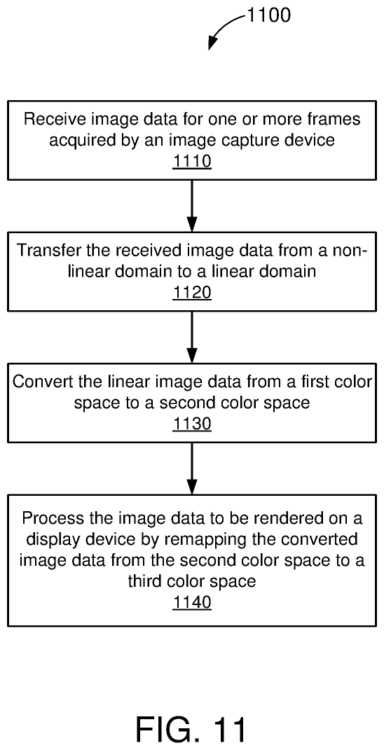

FIG. 11 is an illustrative flowchart depicting an example image processing operation 1100, in accordance with some embodiments. With reference for example to FIG. 1, the operation 1100 may be performed by the DCM 120 to convert image capture data 102 to image render data 103 that can be used to more accurately reproduce the original image on an image display device.

The DCM 120 receives image data for one or more frames acquired by an image capture device (1110). For example, the image capture device may convert the scene light 101 to an electrical signal representing raw RGB values. The image capture device may include an OETF to convert the electrical signals to coded RGB image data that can be used to reproduce the captured image on the image display device, and a CSC to convert the coded RGB image data from the RGB color space to a YUV color space associated with the image capture device. In some aspects, the DCM 120 may receive the YUV image data directly from the image capture device. In some other aspects, the DCM 120 may receive RGB image data after color-space conversion is performed on the YUV image data (e.g., within the VPP 200 of FIG. 2).

The DCM 120 transfers the received image data from a non-linear domain to a linear domain (1120). For example, the coded RGB image data generated by the OETF may correspond to a non-linear signal. In some embodiments, the DCM 120 may include an IOETF to convert the received image data to a linear signal so that image processing can be performed on the linear signal in a more precisely linear domain rather than the non-linear domain. In some aspects, the IOETF may be an inverse of the OETF implemented by the image capture device.

The DCM 120 further converts the linear image data from a first color space to a second color space (1130). It is noted that some electronic devices (including image capture devices and image display devices) operate using the RGB color model. Aspects of the present disclosure recognize that some image processing operations, such as color-space re-mapping, may be more efficient and/or effective to implement in the YUV domain. Thus, in some embodiments, the DCM 120 may include a CSC to convert the received image data from the RGB color space to a YUV color space associated with the image capture device. In some aspects, the YUV color space may define a gamut of the image capture device.

The DCM 120 processes the received image data to be rendered on a display device by remapping the converted image data form the second color space to a third color space (1140). For example, the DCM 120 may include an EETF to bridge the color-space at the source and the color-space at the output by remapping the received image data to a color-space that is better suited for presentation on the display. The received image data may be converted to the YUV color space so that the color-space re-mapping can be performed on substantially linear signal in a more precisely linear domain. Thus, in some embodiments, the EETF (or color-space re-mapper) may re-map the converted image data from the YUV color-space of the image capture device to a YUV color-space that is supported by the image display device. In some embodiments, the DCM 120 may further convert the remapped image data from the YUV color space to an RGB color space of the image capture device which is more suitable for display.

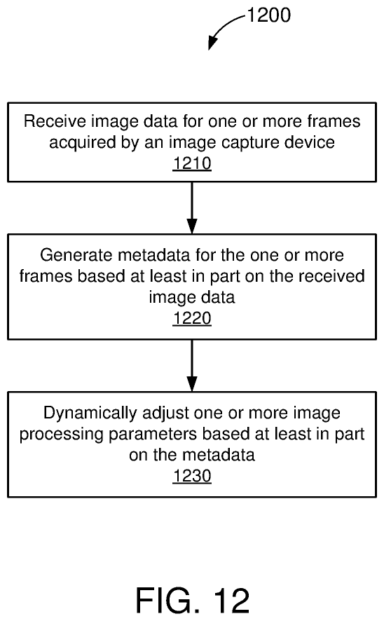

FIG. 12 is an illustrative flowchart depicting an example operation 1200 for dynamic range detection, in accordance with some embodiments. With reference for example to FIG. 9, the operation 1200 may be performed by the dynamic range detector 900 to generate metadata based, at least in part, on image data to be processed by a DCM circuit.

The dynamic range detector 900 receives image data for one or more frames acquired by an image capture device (1210). For example, the image capture device may convert scene light to an electrical signal representing raw RGB values. The image capture device may include an OETF to convert the electrical signals to coded RGB image data that can be used to reproduce the captured image on the image display device, and a CSC to convert the coded RGB image data from the RGB color space to a YUV color space associated with the image capture device. In some aspects, the dynamic range detector 900 may receive the YUV image data directly from the image capture device. In some other aspects, the dynamic range detector 900 may receive RGB image data after color-space conversion is performed on the YUV image data (e.g., within the VPP 200 of FIG. 2).

The dynamic range detector 900 generates metadata for the one or more frames based at least in part on the received image data (1220). For example, the metadata may provide supplemental information about the characteristics and/or properties of the received image data and/or the image source. Example metadata may include, but is not limited to, a data range of the received image data including whether the image data contains full-range color information or narrow-range color information. In some embodiments, the dynamic range detector 900 may generate the metadata based, at least in part, on a minimum luminance value and a maximum luminance value within a given frame or image. In some other embodiments, the dynamic range detector 900 may generate the metadata based, at least in part, on a frequency of the minimum luminance value and a frequency of the maximum luminance value within the given frame or image. Still further, in some embodiments, the dynamic range detector 900 may generate the metadata based, at least in part, on a distribution of luminance values within the given frame or image.

In some embodiments, the dynamic range detector 900 may dynamically adjust one or more image processing parameters based at least in part on the metadata (1230). For example, the metadata may be used to dynamically adjust one or more registers and/or lookup tables (LUTs) to be used in one or more image processing operations. For example, the metadata 803 may be used to adjust the parameters of one or more registers and/or LUTs used by any processing components of the DCM circuit 800 including, but not limited to: color-space converters, full-range expanders, spatial noise reducers, and/or color-space re-mappers.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of image processing, comprising:
receiving image data for one or more frames acquired by an image capture device;
transferring the received image data from a non-linear domain to a linear domain using an inverse opto-electrical transfer function (IOETF);
converting the linear image data from a first color space to a second color space, wherein the first and second color spaces are based on a gamut of the image capture device; and
processing the image data to be rendered on a display device by remapping the converted image data from the second color space to a third color space, wherein the third color space is based on a gamut of the display device.

2. The method of claim 1, wherein the first color space defines the gamut of the image capture device in terms of red, green, and blue (RGB) color components and the second color space defines the gamut of the image capture device in terms of luminance and chrominance (YUV) components.

3. The method of claim 2, wherein the third color space defines the gamut of the display device in terms of YUV components.

4. The method of claim 1, wherein the processing comprises:
converting the remapped image data from the third color space to a fourth color space

5. The method of claim 4, wherein the fourth color space defines the color gamut of the display device in terms of RGB components.

6. The method of claim 1, wherein the processing comprises:
transferring the remapped image data from the linear domain to the non-linear domain using an inverse electro-optical transfer function (IEOTF).

7. The method of claim 1, further comprising:
generating metadata for the one or more frames based at least in part on the received image data; and
dynamically adjusting one or more image processing parameters based at least in part on the metadata.

8. The method of claim 7, wherein the generating comprises, for each frame of the one or more frames:
determining at least one of a maximum luminance value in the frame, a minimum luminance value in the frame, a frequency of the maximum luminance value in the frame, a frequency of the minimum luminance value in the frame, or a distribution of luminance values in the frame.

9. The method of claim 8, wherein the generating further comprises:
determining a data range of the received image data based at least in part on the maximum luminance values and the minimum luminance values for a plurality of the frames.

10. The method of claim 7, wherein the dynamically adjusting comprises, for each frame of the one or more frames:
adjusting one or more lookup tables or registers used in converting the linear image data from the first color space to the second color space or processing the image data to be rendered on the display device.

11. A data conversion and color-space mapping (DCM) circuit, comprising:
a processing system; and
a memory storing instructions that, when executed by the processing system, causes the DCM circuit to:
receive image data for one or more frames acquired by an image capture device;
transfer the image data from a non-linear domain to a linear domain using an inverse opto-electrical transfer function (IOETF);
convert the linear image data from a first color space to a second color space, wherein each of the first and second color spaces is based on a gamut of the image capture device; and
process the image data to be rendered on a display device by remapping the converted image data from the second color space to a third color space, wherein the third color space is based on a gamut of the display device.

12. The DCM circuit of claim 11, wherein the first color space defines the gamut of the image capture device in terms of red, green, and blue (RGB) color components, the second color space defines the gamut of the image capture device in terms of luminance and chrominance (YUV) components, and the third color space defines the gamut of the display device in terms of YUV components.

13. The DCM circuit of claim 11, wherein execution of the instructions further causes the DCM circuit to:
convert the remapped image data from the third color space to a fourth color space, wherein the fourth color space defines the color gamut of the display device in terms of RGB components.

14. The DCM circuit of claim 11, wherein execution of the instructions further causes the DCM circuit to:
transfer the remapped image data from the linear domain to the non-linear domain using an inverse electro-optical transfer function (IEOTF).

15. The DCM circuit of claim 11, wherein execution of the instructions further causes the DCM circuit to:
generate metadata for the one or more frames based at least in part on the received image data; and
dynamically adjust one or more image processing parameters of the DCM circuit based at least in part on the metadata.

16. The DCM circuit of claim 15, wherein execution of the instructions for generating the metadata for each frame of the one or more frames causes the DCM circuit to:
determine at least one of a maximum luminance value in the frame, a minimum luminance value in the frame, a frequency of the maximum luminance value in the frame, a frequency of the minimum luminance value in the frame, or a distribution of luminance values in the frame.

17. The DCM circuit of claim 16, wherein execution of the instructions for generating the metadata further causes the DCM circuit to:
determine a data range of the received image data based at least in part on the maximum luminance values and the minimum luminance values for a plurality of the frames.

18. The DCM circuit of claim 15, wherein execution of the instructions for dynamically adjusting the one or more image processing parameters causes the DCM circuit to:
adjust one or more lookup tables or registers used in converting the linear image data from a first color space to a second color space or processing the image data to be rendered on a display device.

19. A system comprising:
a display device configured to display one or more frames acquired by an image capture device; and
a data conversion and color-space mapping (DCM) circuit configured to:
receive image data for the one or more frames;
transfer the received image data from a non-linear domain to a linear domain using an inverse opto-electrical transfer function (IOETF);
convert the linear image data from a first color space to a second color space, wherein the first and second color spaces are based on a gamut of the image capture device; and
remap the converted image data from the second color space to a third color space, wherein the third color space is based on a gamut of the display device.

20. The system of claim 19, further comprising:
a dynamic range detector configured to:
generate metadata for the one or more frames based at least in part on the received image data; and
dynamically adjust one or more image processing parameters of the DCM circuit based at least in part on the metadata.
